(19) United States
(12) Patent Application Publication
(10) Pub. No.: US 2009/0288071 A1
(43) Pub. Date: Nov. 19, 2009

(54) TECHNIQUES FOR DELIVERING THIRD PARTY UPDATES

(75) Inventors: David L. Seidman, Bellevue, WA (US); Chika P. Ekeji, Kirkland, WA (US); Michael E. Walsh, JR., Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/119,501

(22) Filed: May 13, 2008

(51) Int. Cl. G06F 9/44

(52) U.S. Cl. 717/126; 717/171

(57) ABSTRACT

Various technologies and techniques are disclosed for receiving and distributing updates for third party customers to end users. Input is received from a customer to login to a software update system. A software update is received from the customer. Metadata describing the software update is received from the customer. The software update is optionally validated to confirm that the software update can be trusted by end users who have a software program that could be updated with the software update. The software update is made available to update systems running on computers of end users after receiving the customer consent to the release of the software update.

### BACKGROUND

A typical computer user has software installed on his/her computer from various different companies. The programs occasionally need to be updated for security or functionality reasons. Each company typically provides its own update system that installs updates for that particular company's products. In some cases, there is one program per product within a company. Each update system consumes system resources on the user's computer. While tools exist for enterprise customers to deploy updates to multiple computers on their network, these tools have the administrator manually specify which updates are needed on the end user computers.

### SUMMARY

Various technologies and techniques are disclosed for receiving and distributing updates for third party customers to end users. Input is received from a customer to login to a software update system. A software update is received from the customer. Metadata describing the software update is received from the customer. The software update is optionally validated to confirm that the software update can be trusted by end users who have a software program that could be updated with the software update. In one implementation, the software update is published to a test system to enable the customer to test and approve the software update before distribution to end users. The software update is made available to update systems running on computers of end users after receiving customer consent to the release of the software update.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic view of a third party customer update system of one implementation.

FIG. 2 is a process flow diagram for one implementation illustrating the stages involved in receiving one or more software updates from a third party customer.

FIG. 3 is a process flow diagram for one implementation illustrating the stages involved in performing a validation process on the one or more software updates received from a third party customer.

FIG. 4 is a diagrammatic view of some exemplary validation tests that can be performed to validate one or more software updates received from a third party customer.

FIG. 5 is a process flow diagram for one implementation illustrating the stages involved in enabling the third party customer to test the one or more software updates before making them available to end users.

FIG. 6 is a process flow diagram for one implementation illustrating the stages involved in installing the software updates through an update system installed on end user computers.

FIG. 7 is a diagrammatic view of a computer system of one implementation.

### DETAILED DESCRIPTION

The technologies and techniques herein may be described in the general context as techniques for receiving and distributing updates for third party customers to end users, but the technologies and techniques also serve other purposes in addition to these. In one implementation, one or more of the techniques described herein can be implemented as features within a software update system that runs on a client and/or on a server.

In one implementation, a unified update system is described that consolidates the updates from multiple third party customers into an automatic detection-and-installation system. A software update is received from a third party customer (such as a software manufacturer) and validated in an automated way to ensure that the software update can be trusted. Third party customers can test the updates before they are made available for distribution to end users. The approved software updates are then delivered to client update systems that run on end user computers. The client update system thus reduces the number of separate update systems that the client computer runs in order to receive updates to the various third party software products installed in that user's computer.

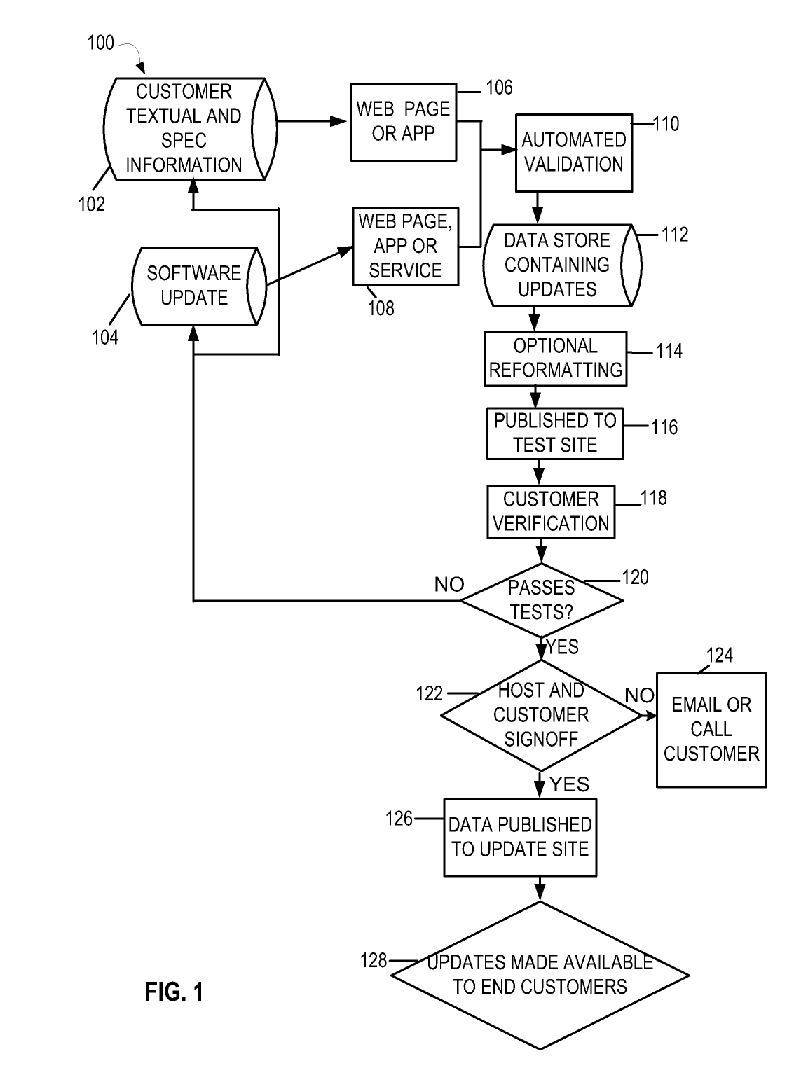

FIG. 1 is a high level diagrammatic view of a third party customer update system 100 of one implementation. There are three conceptual components of customer update system 100. There is the receiving of the software updates from third party customers, the validation of the software updates, and the distribution of the software updates to end users. Each of these will be discussed at a high level, and then more detail provided in the figures that follow.

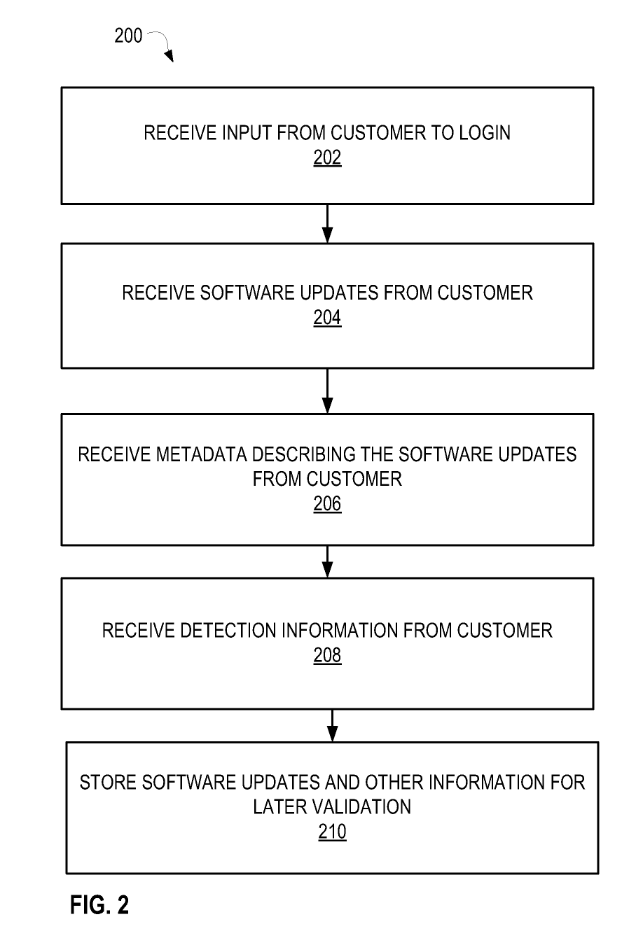

Software update textual and specification information is received from a third party customer (stage 102) through a web page or other application (stage 106). The software update 104 is also received from the customer through a web page, other application or service 108. The process for receiving software updates from third party customers is described in further detail in FIG. 2. An automated validation process is then performed on the information to confirm that the software update can be trusted (stage 10). In some implementations, a validation process is not performed at all, but the software updates are just made available to computers of end users after the customer adds them to the customer update system 100.

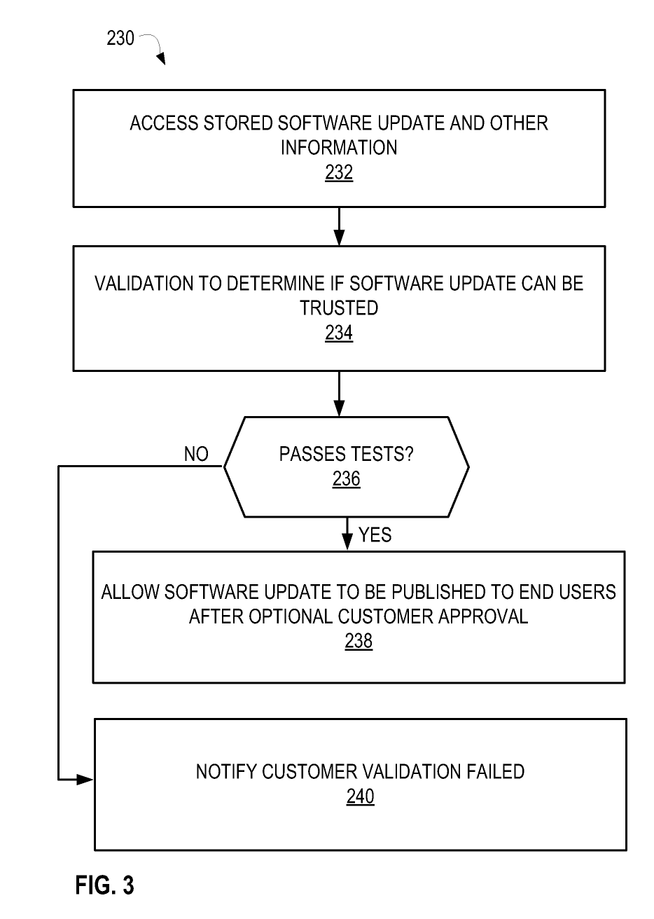

The software update is stored in a data store containing the update (stage 112). The information received from the customer is optionally reformatted to include any necessary formatting to make it suitable for distribution to end users (stage 1 14). The software update is optionally published to a test site (stage 116) to enable the customer to verify that the update is ready for distribution (stage 1 18). If the validation tests fail (decision point 120), then the customer is given an opportunity to correct the software update and/or information (stage 102 and 104). The validation of a software update after it is received from a customer is described in further detail in FIGS. 3-5.

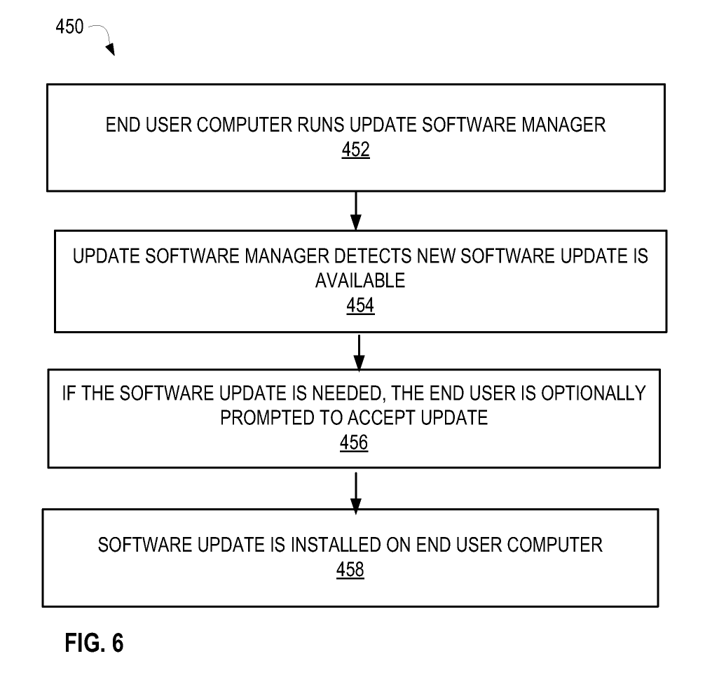

Once the hosting company and/or third party customer signoff on the release of the software update (decision point 122), then the data is published to the update site (state 126) and the updates are made available to end users through the client update systems on the computers of the end users (stage 128). If the signoff is not received (decision point 122), then the customer can be emailed, called, or otherwise contacted regarding the issue (stage 124) to be given an opportunity to correct. The delivery of the software update to end users is described in further detail in FIG. 6).

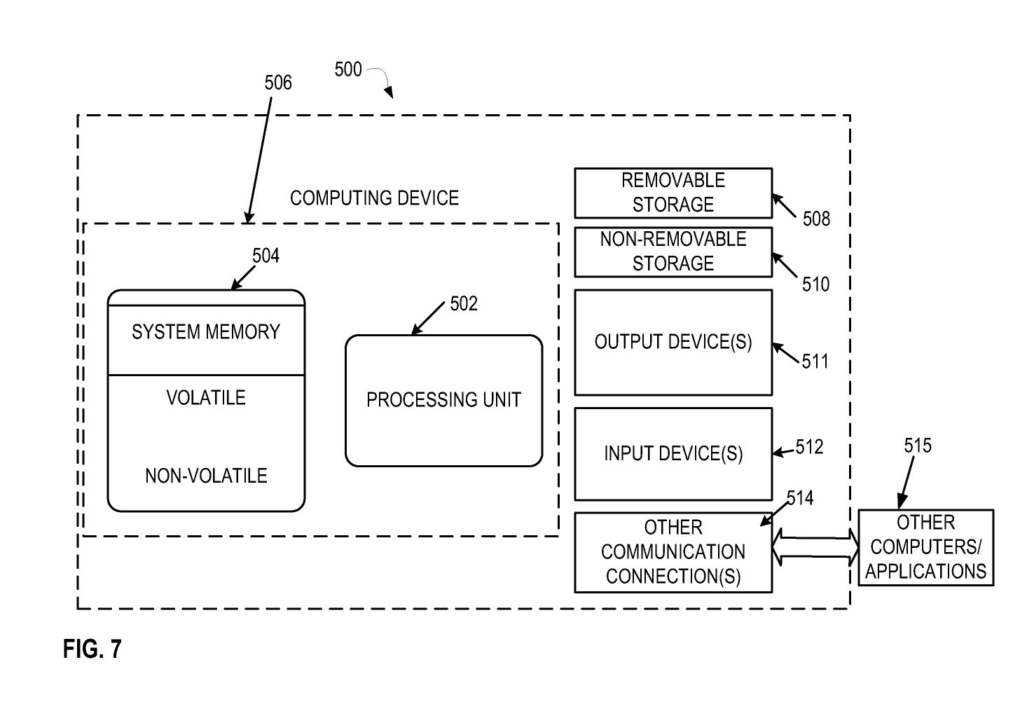

Turning now to FIGS. 2-6, the stages for implementing one or more implementations of third party customer update system 100 is described in further detail. In some implementations, the processes of FIG. 2-6 are at least partially implemented in the operating logic of computing device 500 (of FIG. 7).

FIG. 2 is a process flow diagram for one implementation illustrating the stages involved in receiving one or more software updates from a third party customer. The term “customer” and “third party customer” as used herein is meant to include an entity, individual, or their designated representative who is providing updates for their software to be distributed to the end users of their software. Input is received from the customer to login to the update system (stage 202). In one implementation, the customer logs in with a secure log-in mechanism, which makes use of available technologies for user authentication. The user representing the customer may have only limited rights within the system. Once logged in, the customer can select an option to create a new project for a software update. One or more software updates are then received from the customer (stage 204). These software updates can take any of several forms, such as an executable file, dynamic link library (DLL), or any other type of format that could be utilized or processed by the end user computers. In one implementation, the customer is able to specify multiple patches to support variations in platform (32 bit vs. 64 bit), language, and software version, among other attributes.

Metadata describing the software update(s) is also received from the customer (stage 206). The metadata can include things like company name, hyperlinks to documentation and support information, intended ship date, and patch type (service pack, security, non-security, optional).

Detection information is optionally received from the customer (stage 208). The customer can provide information such as registry keys, file names and file versions that can be used to determine when the update is needed. In one implementation, an XML format is used to capture this information that is parsed by client-side code during the detection step later in the process. In such an implementation, this XML is exposed to the customer to allow them to generate detection information either through a UI or programmatically. In another implementation, a direct interface is provided with a customer's build process, so that the customer could automatically provide detection information to the update system 100 without human intervention. This would happen through automatic generation of the detection XML by the customer's build process. The software update(s) and other information are stored for later validation (stage 210). After software update(s) are received from the customer, the validation process is then performed, as described in FIG. 3.

FIG. 3 is a process flow diagram for one implementation illustrating the stages involved in performing a validation process on the one or more software updates received from a third party customer. The system accesses the stored software update and other information (stage 232). A validation process is performed to determine if the software update can be trusted (stage 234). If the software update passes the tests (decision point 236), then the software update can be published to end users after optional customer approval (stage 238). If the software update does not pass the validation tests (decision point 236), then the customer is notified that the validation failed so they can be given an opportunity to correct it (stage 240).

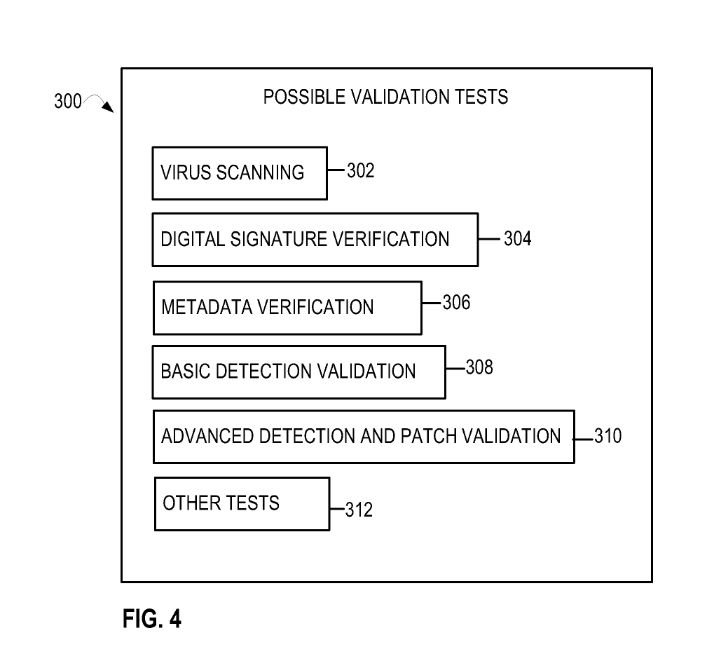

In one implementation, if any part of the validation process fails, then the process halts until the failure is resolved. The customer may be contacted manually or automatically. Once the error is corrected by entering new data or uploading new updates, the validation is re-run, and the process continues. In other implementations, a validation process is not utilized at all, and software updates are simply accepted from the customer and then made available to the computers of end users. Some example validations that can be used during a validation process will now be described in FIG. 4.

FIG. 4 is a diagrammatic view of some exemplary validation tests that can be performed to validate one or more software updates received from a third party customer. Virus scanning 302 can be performed on the software update to ensure that the software update does not contain a virus. Digital signature verification 304 can be performed on the software update to ensure that an entity represented by the customer who is uploading the software update matches an entity assigned to a digital signature present on the software update. Metadata verification 308 can be performed to confirm that metadata contained in the software update matches metadata entered by the customer into the software update system.

Basic detection validation 308 can be performed against the software update. To do so, the software program is installed on a test computer. The validation process verifies that the software update is offered and installs. The validation process also verifies that the software update is no longer offered once it has been installed. If an uninstall option is available, then the validation process uninstalls the software update and verifies that the software update is offered again. In one implementation, in order to successfully conduct this step, the customer would need to provide either copies or virtualized images of their software. Alternately, the host of the third party update system 100 may make this automation available for the customers to run directly.

Alternatively or additionally, advanced detection and patch validation 310 can be performed against the software update. The validation process can determine if the software update affects files outside of an installed directory of the software program. The validation process can determine if the software update affects a correct set of files as indicated by the metadata entered by the customer into the software update system. The validation process can determine if the software program loads after the software update is installed. Alternatively or additionally, the validation process can determine if the software update functions properly if the software program is not installed in the default location or configuration.

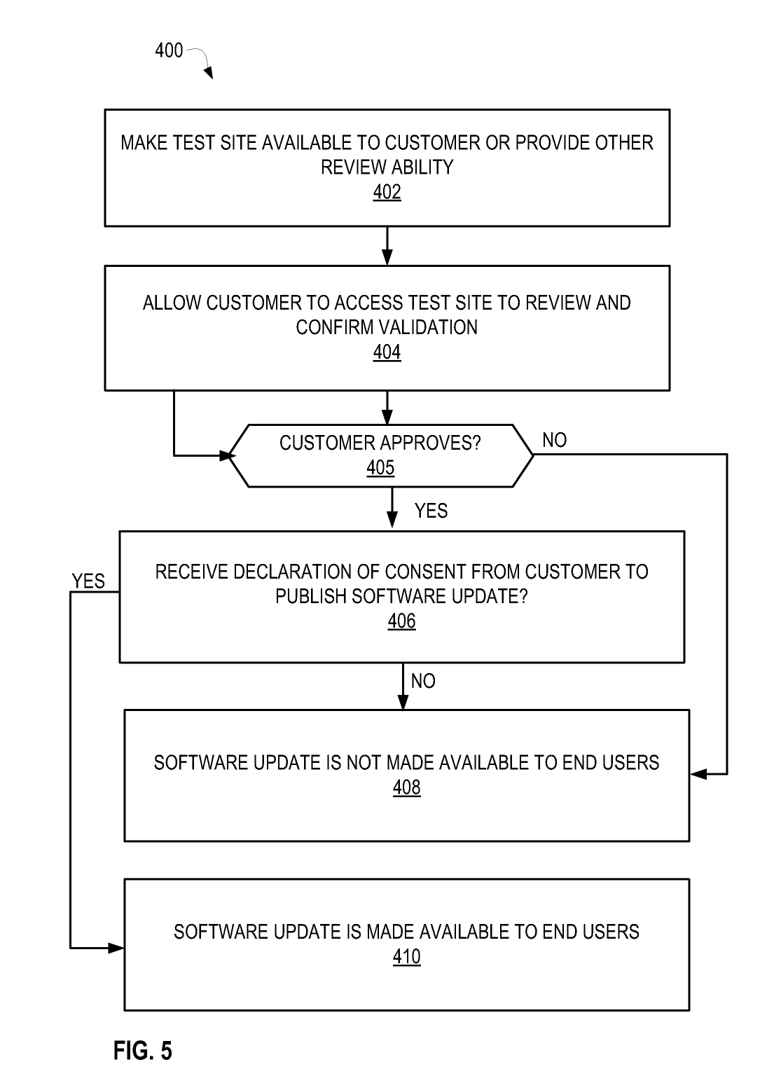

FIG. 5 is a process flow diagram for one implementation illustrating the stages involved in enabling the third party customer to test the one or more software updates before making them available to end users. A test site is made available to the customer, or some other ability for the customer to view and verify the software update is made available to the customer (stage 402). The customer can access the test site to review and confirm the validation of the software update (stage 404). If the customer approves the software update after validation (decision point 405), then the customer is prompted for a declaration of consent (decision point 406). In other words, after validating the updates, the customer would then affirm that certain conditions have been met. This would include a passing virus scan, affirmation that the patch detects and installs properly, and other quality signoffs. The final signoff would be a declaration of consent and intent to publish the patch.

If a declaration of content is received from the customer, then the software update is made available to end users (stage 410). If the declaration of consent is not received from the customer (decision point 406), then the software update is not made available to end users (stage 408). The steps can be repeated for a plurality of software updates.

The test system only allows the customer to view their own updates and not the updates of different customers. Some exemplary implementations of how to accomplish this security restriction will be described next. In one implementation, a separate detection catalog can be created that contains only that customer's updates. A detection catalog is a compiled set of all information, including the software update and related information that is necessary for distributing the software update. Each customer's catalog would then be published to a separate testing site. That site would be a replica of the main site but, because the update catalog is restricted, only that customer's updates would be displayed. Optionally, we could allow companies to grant global or specific permission for others to see their updates, so that (for example) two customers could coordinate shipment of a fix that affects both companies' products.

In another implementation, a single test site can be created but that selectively displays updates during the detection or display stages. This would be accomplished by matching the customer in the update's metadata against the customer's login information. In yet another implementation, the test site is a replica of the main site but displaying only that customer's updates. The customer can then perform detect-and-install tests just as a customer would. This provides customers with the ability to validate their detection logic.

FIG. 6 is a process flow diagram for one implementation illustrating the stages involved in installing the software updates through an update system installed on end user computers. The end user's computer runs a client update system (stage 452). The client update system detects that a new software update is available (stage 454). This detection can be triggered in one or more ways. For example, when the end user visits the third party update system website or otherwise triggers the scanning agent of the client update system, the client update system downloads the detection information to the end user's system, and then runs the tests called for in the detection logic. If it is determined that the software update is needed, the end user is optionally offered the software update via the website or other appropriate user interface (stage 456). If the user elects to install the software update, then the software update is installed on the end user's computer (stage 458). In some implementations, the client update system may automatically install the patch without prompting the user. The steps are repeated for a plurality of end user computers who have the client update system installed and need their software updated by the software update.

As shown in FIG. 7, an exemplary computer system to use for implementing one or more parts of the system includes a computing device, such as computing device 500. In its most basic configuration, computing device 500 typically includes at least one processing unit 502 and memory 504. Depending on the exact configuration and type of computing device, memory 504 may be volatile (such as RAM), non-volatile (such as ROM, flash memory, etc.) or some combination of the two. This most basic configuration is illustrated in FIG. 7 by dashed line 506.

Additionally, device 500 may also have additional features/functionality. For example, device 500 may also include additional storage (removable and/or non-removable) including, but not limited to, magnetic or optical disks or tape. Such additional storage is illustrated in FIG. 7 by removable storage 508 and non-removable storage 510. Computer storage media includes volatile and nonvolatile, removable and non-removable media implemented in any method or technology for storage of information such as computer readable instructions, data structures, program modules or other data. Memory 504, removable storage 508 and non-removable storage 510 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 500. Any such computer storage media may be part of device 500.

Computing device 500 includes one or more communication connections 514 that allow computing device 500 to communicate with other computers/applications 515. Device 500 may also have input device(s) 512 such as keyboard, mouse, pen, voice input device, touch input device, etc. Output device(s) 511 such as a display, speakers, printer, etc. may also be included. These devices are well known in the art and need not be discussed at length here.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the examples discussed herein could be organized differently on one or more computers to include fewer or additional options or features than as portrayed in the examples.

What is claimed is:

1. A method for receiving and validating updates from third party customers for later distribution to end users comprising the steps of:
receiving input from a customer to login to a software update system;
receiving a software update from the customer;
receiving metadata describing the software update from the customer; and
validating the software update to confirm that the software update can be trusted by end users who have a software program that could be updated with the software update.

2. The method of claim 1, further comprising the steps of:
receiving detection information from the customer that specifies how to determine if the software update applies to a given end user.

3. The method of claim 1, further comprising the steps of:
storing the software update in the software update system for access by an update system that runs on respective computers of the end users.

4. The method of claim 1, wherein the validating step comprises the steps of:
performing virus scanning on the software update to ensure that the software update does not contain a virus.

5. The method of claim 1, wherein the validating step comprises the steps of:
performing digital signature verification on the software update to ensure that an entity represented by the customer who is uploading the software update matches an entity assigned to a digital signature present on the software update.

6. The method of claim 1, wherein the validating step comprises the steps of:
performing metadata verification to confirm that metadata contained in the software update matches metadata entered by the customer into the software update system.

7. The method of claim 1, wherein the validating step comprises the steps of:
performing a basic detection validation that comprises the steps of:
installing the software program;
verifying that the software update is offered and installs; and
verifying that the software update is no longer offered.

8. The method of claim 7, wherein the basic detection validation step further comprises the steps of:
if an uninstall option is available, uninstalling the software update and verifying that the software update is offered again.

9. The method of claim 1, wherein the validating step comprises the steps of:
determining if the software update affects a correct set of files as indicated by the metadata entered by the customer into the software update system.

10. The method of claim 1, wherein the validating step comprises the steps of:
determining if the software program loads after the software update is installed.

11. The method of claim 1, wherein the validating step comprises the steps of:
performing virus scanning on the software update to ensure that the software update does not contain a virus;
performing digital signature verification on the software update to ensure that an entity represented by the customer who is uploading the software update matches an entity assigned to a digital signature present on the software update; and
performing metadata verification to confirm that metadata contained in the software update matches metadata entered by the customer into the software update system.

12. The method of claim 1, further comprising the steps of:
providing a test system to enable the customer to test and approve the software update before the software update is made available to end users.

13. A method for enabling customer verification of software updates before the software updates are made available to end users comprising the steps of:
enabling a customer to access a test system for testing a software update that was previously submitted by the customer for distribution to end user computers through a centralized update system;
if the customer approves the software update after testing the software update, receiving consent from the customer to publish the software update to make the software update available to an update system that runs on the end user computers; and
if the customer does not approve the software update after testing the software update, then not making the software update available to an update system that runs on the end user computers.

14. The method of claim 13, wherein the testing system contains software updates from a plurality of different customers.

15. The method of claim 14, wherein the testing system only allows the customer to view software updates that were submitted by the customer, and to not allow the customer to view software updates that were submitted by other customers.

16. The method of claim 13, wherein the testing system contains software updates that were submitted by the customer, but not software updates that were submitted by other customers.

17. The method of claim 16, wherein a separate testing system is created for software updates that were submitted by other customers.

18. A computer-readable medium having computer-executable instructions for causing a computer to perform steps comprising:
receiving input from a customer to login to a software update system;
receiving a software update from the customer;
receiving metadata describing the software update from the customer; and
making the software update available to update systems running on computers of end users after receiving verification that the customer has consented to the release of the software update.

19. The computer-readable medium of claim 18, further having computer-executable instructions for causing a computer to perform steps comprising:
prior to making the software update available to update systems running on computers of end users, first validating the software update to confirm that the software update can be trusted by end users who have a software program that could be updated with the software update; and
receiving verification that the customer has consented to the release by publishing the software update to a test system to enable the customer to test the software update and provide consent to the release before distribution to end users.

20. The computer-readable medium of claim 19, wherein the validating step is operable to perform steps comprising:
performing digital signature verification on the software update to ensure that an entity represented by the customer who is uploading the software update matches an entity assigned to a digital signature present on the software update;
performing virus scanning on the software update to ensure that the software update does not contain a virus; and
performing metadata verification to confirm that metadata contained in the software update matches metadata entered by the customer into the software update system.
